(19) United States
(12) Patent Application Publication
(10) Pub. No.: US 2012/0239429 A1
(43) Pub. Date: Sep. 20, 2012

(54) Apparatuses and Methods to Recognize and Optimize Medical Invoice Billing Codes

(75) Inventor: Charles Corfield, Boulder, CO (US)

(73) Assignee: NVOQ INCORPORATED, Boulder, CO (US)

(21) Appl. No.: 13/410,971

(22) Filed: Mar. 2, 2012

Related U.S. Application Data
(60) Provisional application No. 61/452,223, filed on Mar. 14, 2011.

(51) Int. Cl. G06Q 50/24

(52) U.S. Cl. 705/3

(57) ABSTRACT

A system for generating health records with optimized insurance coding to maximize revenue is provided. The system provides an invoice coding engine that inspects the health care provider's documentation or notes, possibly in real time as s/he creates it, and matches the notes to generally accepted terms provided by, for example, Current Procedural Terminology database (CPT) and the International Statistical Classification of Diseases and Related Health Problems database (ICD) that correspond to acceptable insurance invoice codes. The invoice coding engine rank orders the generally accepted terms according to their reimbursable value, taking into account the patient's insurer, locality, and the like. The health record is subsequently submitted for invoicing.

### CLAIM OF PRIORITY UNDER 35 U.S.C. §§119 AND 120

The present application claims priority to U.S. Provisional Patent Application Ser. No. 61/452,223, filed Mar. 14, 2011, and incorporated herein by reference as if set out in full.

### REFERENCE TO CO-PENDING APPLICATIONS FOR PATENT

None.

### BACKGROUND

1. Field

The technology of the present application relates generally to using medical records to facilitate invoicing insurance companies or other third party payers, and more particular, to apparatuses and methods to recognize information contained in a patient evaluation document, to identify at least one insurance code relating to the information, and to optimize the at least one identified insurance code to maximize the revenue returned to the medical provider.

2. Background

Third party payers (i.e., insurance companies) currently pay invoices from health care providers for medical services the health care providers provide to patients. To receive compensation for the services, in most cases, the health care provider submits invoices coded to particular insurance company standardized payment codes.

By way of background, a patient visits a health care provider, such as a doctor, nurse, nurse practitioner, physician's assistant, etc., (generically doctor) for a particular reason. The reasons may be generally minor, such as a typical infection or cold, or generally major, such as neurological problems, immune system deficiencies, metabolic diseases or the like. The health care provider using standards of care typical for such providers takes notes and updates the required medical information in the patient's medical records.

In the normal course, the doctor's notes are sent to a transcription service that specializes in transcribing the doctor's notes into an acceptable (and legible) medical record relating to the visit. The transcribed notes may be reviewed and approved by the doctor. The medical record, which includes the extent of the physical examination, the complexity of the medical service provided, and other necessary background information is provided to an insurance coder/biller (generically coder). The coder reviews the file to determine the service that will be invoiced to the insurance company. The coder translates the information into a numerical code from the Current Procedural Terminology database (CPT) and the International Statistical Classification of Diseases and Related Health Problems database (ICD). While these two databases are generally used and approved in the United States, other databases may be used in other countries; moreover, the databases may change from time to time. For example, the CPT is currently managed by the American Medical Association and the ICD is managed by the World Health Organization.

Once the appropriate codes are determined, the coder (or a separate biller) transmits an invoice to the insurance company. While not necessary, the invoice is typically submitted electronically using a standardized file format, such as the format currently outlined by the American National Standards Institute in ANSI 837 among others, and transmitting the file using an electronic data interchange of some type. Alternatively, a paper invoice may be mailed to a payer clearinghouse.

Once received, the insurance company reviews the invoice. Assuming the invoice is in order, the insurance company reimburses the health care provider using standardized reimbursement formulas. The standardized formulas may include information such as, for example, the “prevailing rate” in a given locale for a particular service, a negotiated rate between the health care provider and the insurance company, etc. The reimbursement values may be generally available in a variety of accessible databases.

Because the insurance company pays invoices for services based on the codes, frequently, the insurance company disputes the proper codes provided on the invoice. Moreover, the invoiced amount often is higher than the agreed upon rate from the insurance company. Thus, many insurance invoices are initially rejected or partially paid. For example, a standard “well care” visit may be invoiced by the doctor at $100.00 (United States Dollars (“USD”)). The agreement between the insurance company and the doctor, however, may allow for a negotiated rate of $70.00 (USD). Thus, a contractual adjustment of $30.00 (USD) may be applied to the invoice. The actual amount paid by the insurance company would be further reduced by any deductibles and co-pays, etc.

Thus, against this background, it is desirable to develop improved apparatuses and methods to transcribe medical records, determine codes, and invoice insurance companies or other 3rd party payers.

### SUMMARY

To attain the advantages and in accordance with the purpose of the technology of the present application, a networked computer system may be provided. The networked computer system is configured to receive transcribed medical records related to a patient medical encounter and compare the medical records to databases containing approved invoice codes for medical encounters. The networked computer system determines a plurality of applicable codes that could be used for invoicing the medical encounter and ranks the applicable codes based on an accepted reimbursement value.

In certain embodiments, the technology of the present application may relate to a networked computer system configured to receive an audio file associated with the dictated notes of a health care provider documenting the medical encounter. The networked computer system would route the audio file to a speech to text engine that would convert the audio file to a textual file. The textual file optionally may be reviewed for accuracy. The textual file may be returned in real or near real time.

In certain embodiments, the technology of the present application may relate to a networked computer system that automatically selects the appropriate code for invoicing and formats an invoice using the appropriate code. The technology of the present application may be configured to electronically submit the invoice to the insurance company using an electronic data interchange.

In certain embodiments, the technology of the present application may relate to a networked computer system that provides information in real time or near real time to the doctor during the patient encounter suggesting codes that may be applicable to an ongoing patient encounter to facilitate the doctor's documentation of the patient encounter optimally for any particular invoice code.

In certain other embodiments, the technology of the present application may relate to a networked computer system that provides selections to the doctor based on the health record, either in real time (based on dictation and typing by the doctor to update the electronic health records) or during subsequent review (based on a review of the electronic health records after transcription). The selections may be ranked based on a calculated reimbursement value.

The foregoing and other features, utilities and advantages of the invention will be apparent from the following more particular description of a preferred embodiment of the invention as illustrated in the accompanying drawings.

### BRIEF DESCRIPTION OF THE DRAWINGS

FIG. 1 is a functional block diagram of an exemplary system consistent with the technology of the present application;

FIG. 2 is a functional block diagram illustrative of a methodology consistent with the technology of the present application

FIGS. 2A-C are functional block diagrams illustrative of a methodology consistent with the technology of the present application;

FIG. 3 is a functional block diagram illustrative of a methodology consistent with the technology of the present application;

FIG. 4 is a functional block diagram of an exemplary system consistent with the technology of the present application; and

FIG. 5 is a functional block diagram of an exemplary workstation consistent with the technology of the present application.

### DETAILED DESCRIPTION

The technology of the present application will now be explained with reference to the figures. While the technology of the present application is described with relation to a doctor/patient encounter, one of ordinary skill in the art will recognize on reading the disclosure that other configurations are possible. For example, the technology could similarly be employed in other 3rd party payer situations where negotiated or contractual rates are applicable including pharmaceuticals, medical equipment, therapies, or the like. Moreover, the technology of the present application will be described with reference to particular discrete processors, modules, or parts, but one of ordinary skill in the art will recognize on reading the disclosure that processors may be integrated into a single processor or server or separated into multiple processors or servers. Moreover, the technology of the present application will be described generically and may be loaded onto a particular user's workstation (fat or thick client) or hosted by a server that is accessed by the workstation (thin client). Additionally, the technology of the present application is described with regard to certain exemplary embodiments. The word “exemplary” is used herein to mean “serving as an example, instance, or illustration.” Any embodiment described herein as “exemplary” is not necessarily to be construed as preferred or advantageous over other embodiments. All embodiments described herein should be considered exemplary unless otherwise stated.

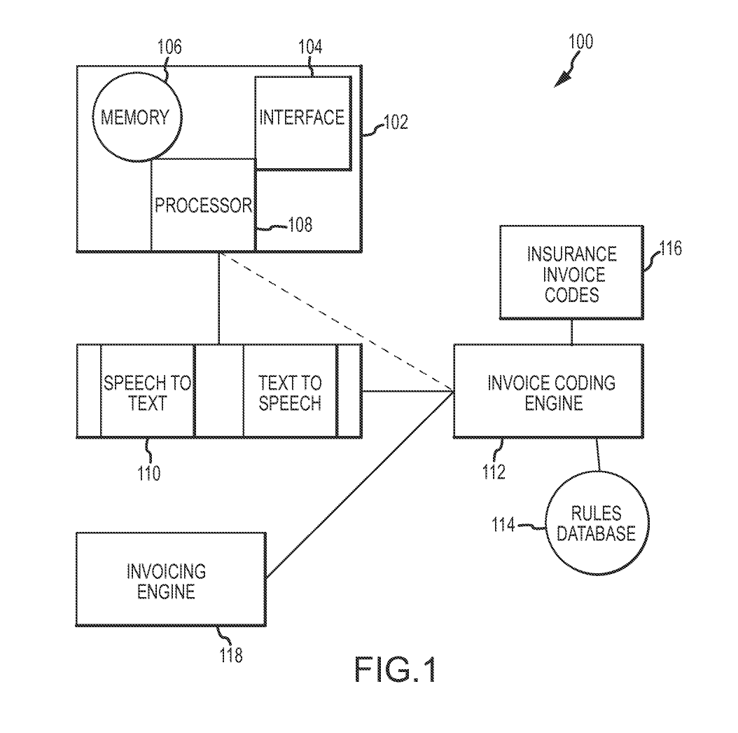

Referring first to FIG. 1, an invoice billing code system 100 consistent with the technology of the present application is shown. The invoice billing code system 100 may comprise a centralized or dispersed number of workstations that receive and process data and information from a number of health care providers. The description that follows, however, relates to the invoice billing code system 100 receiving and processing data from a single health care provider for convenience as the system would operate in substantially the same manner when working with many providers.

The invoice billing code system 100 includes both voice and audio signals as appropriate for the data that traverses the signaling and audio paths described herein. As described above, the system may be hosted remotely from the workstation (thin client) or downloaded to the workstation (fat or thick client). Communication lines typically allow the transport of both audio and data signals. The invoice billing code system 100 includes devices, software modules, hardware components and wiring to support the various functions as described herein.

Referring back to FIG. 1, the invoice billing code system 100 is shown in more detail. Invoice billing code system 100 may include a workstation 102 having a user interface 104 to accept information relating to a patient encounter. The workstation 102 may be a conventional computer such as, for example, a laptop computer, a desktop computer, a tablet computer, smart phone, personal digital assistant or the like. A doctor may directly input the patient encounter using workstation 102, such as, by typing or dictation. Alternatively, a transcriptionist or secretary may interact with the interface 104 to input a doctor's notes to workstation 102. For example, the transcriptionist may listen to an audio file of the doctor's notes and use a keyboard to type the notes. Alternatively, the secretary may read the doctor's file notes and interact with the interface 104 to input a doctor's notes to workstation 102. In some embodiments, the interface 104 is a microphone to allow the doctor to dictate his notes to workstation 102. The workstation 102 may include a memory 106 to store the textual files or audio files. Of course, the interface 104 may be one or a combination of a number of conventional basic input systems such as, for example, a keyboard and display system, a light pen, touch screen, microphone, or the like. Interface 104 also may have a display, a speaker, a printer, or the like connected to allow information to be provided back to the user, whether a doctor, transcriptionist, or the like as is generally known in the art. The workstation 102 (which is described in more detail below) also includes a processor 108. Processor 108 may interact with a remote server 110 for certain applications and functionality. For example, one remote server 110 may include a speech to text engine 110ₛₜₜ to convert audio data to textual data. In certain embodiments, the remote server 110 also may include a text to speech engine 110ₜₜₛ to convert textual data to audio data. Alternatively, for example, the processor 108 may comprise sufficient capability to perform the applications or functions needed. In this case, workstation 102 may incorporate a speech to text engine and/or a text to speech engine in processor 108 or as circuitry or modules.

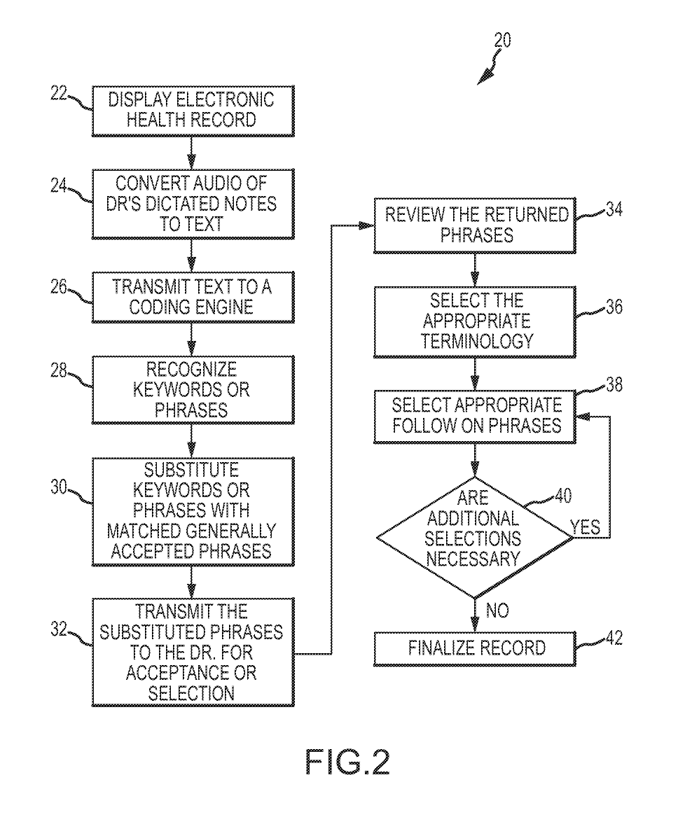

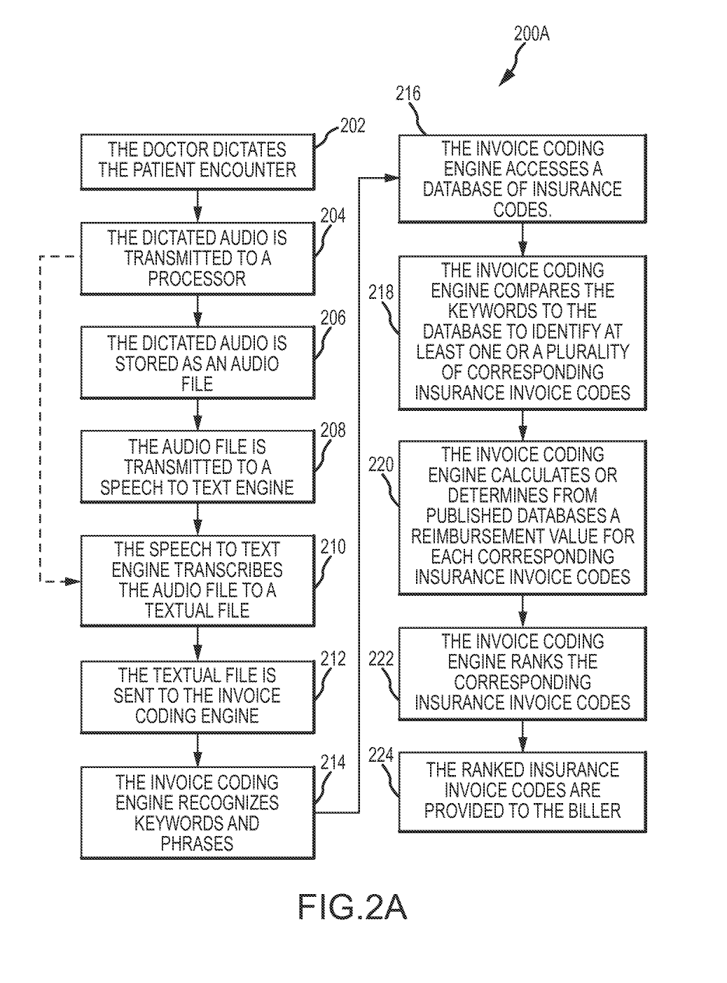

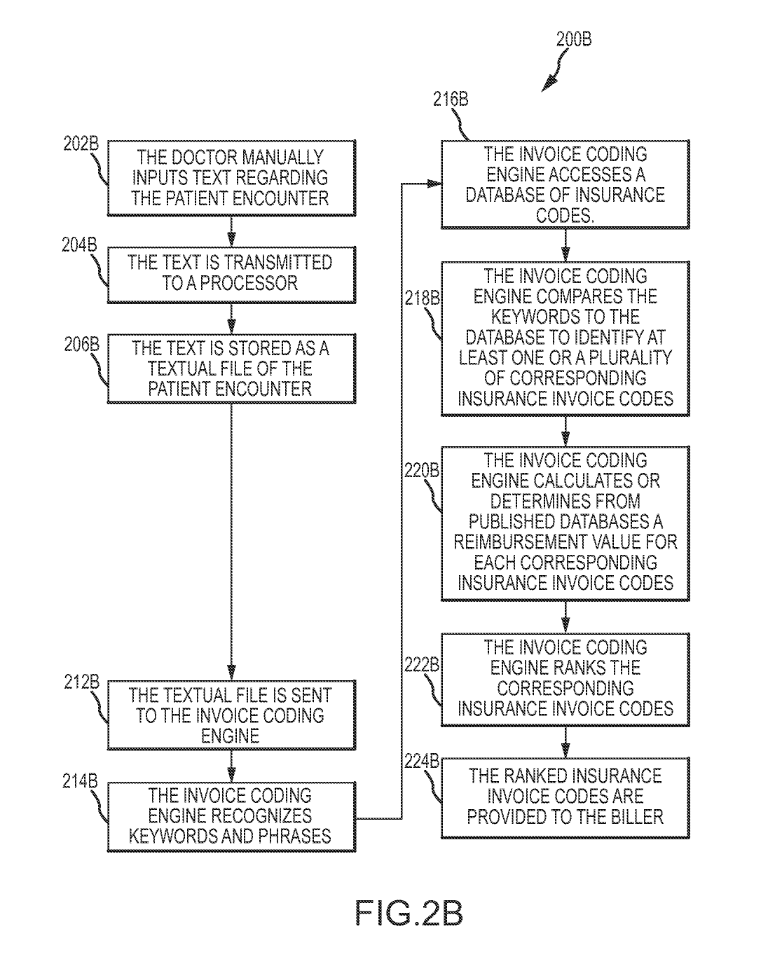

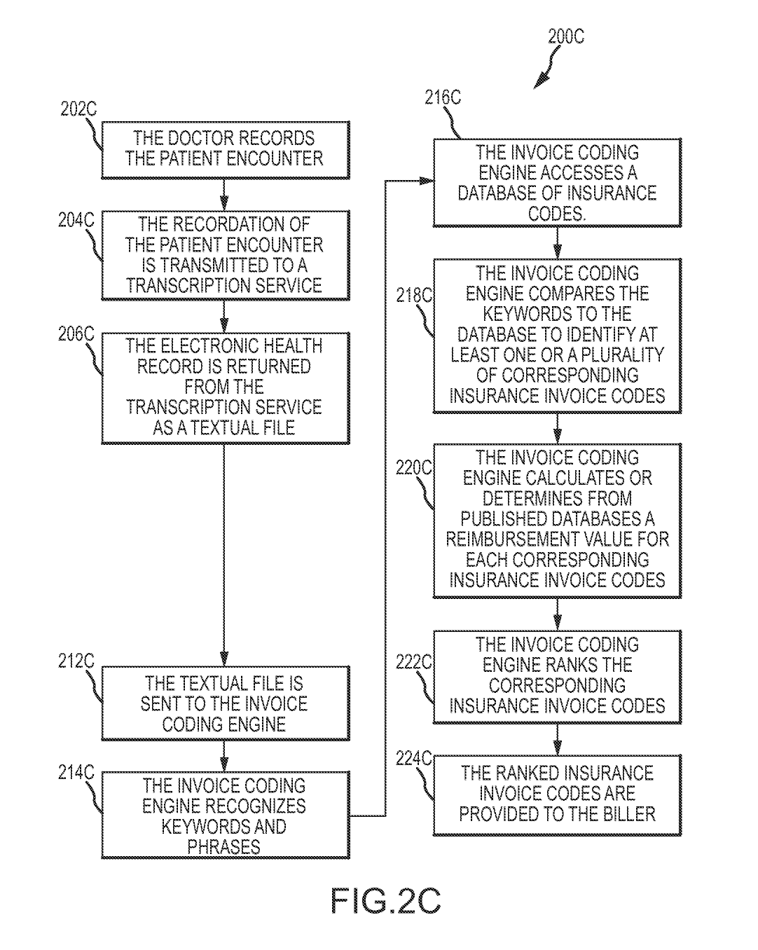

Many records of patient encounters are now electronically recorded as electronic health records. The information, as described herein, may be input to the electronic health record for any particular patient encounter using real or near real time mechanisms, such as, for example, directly typing the records by the doctor or using an automatic real time dictation system such the SayIt™ product available from nVoq Incorporated located in Boulder, Colo. The information also may be input using batch or non-real time mechanisms, such as, for example, transcription services (which may be an electronic dictation system or a trained transcriptionist). Once available as an electronic health record, the electronic health record may be processed by the invoice coding engine to facilitate the doctor's recordation of the patient encounter. For example, with reference to FIG. 2, a flowchart 20 is provided showing an interaction between the doctor and the electronic health record as it is being processed. While flowchart 20 is provided in certain discrete steps, one of ordinary skill in the art will recognize that the steps identified may be broken into multiple steps or multiple steps in the flowchart may be combined into a single step. Moreover, the sequence of events provided by the flowchart may be altered or rearranged without departing from the technology of the present application. Additionally, the following exemplary embodiment is in relation to a single medical diagnosis/condition. The fact that only one condition is provided should not be considered limiting. Flowchart 20 could occur in real or near real time to the actual patient encounter or be subsequent to the patient encounter and part of a doctor's review of the electronic health record. With the above in mind, the electronic health record would be displayed to the doctor or health care provider for review, step 22. Notably, the electronic health record is or has been processed by the invoice coding engine 112. The invoice coding engine includes a processor, a recognizer module, and a comparator module. For example, a patient may present to a health care provider based on a seizure condition. The doctor may, for example, dictate the note as “The patient exhibited a seizure based on XYZ conditions.” The doctor's notes would be converted to an electronic health record textual file, step 24 (whether in real time, near real time, or subsequently). The textual file would be transmitted to the invoice coding engine 112, step 26, that uses the recognizer module to recognize keywords, phrases, or the like in the textual file associated with medical coding, step 28. These keywords, phrases, and the like (generically “key data”) would be generally associated with, for example, the CPT or ICD. The invoice coding engine 112 would use the comparator module to match the recognized key data to generally accepted phrases from the CPT or ICD. The invoice coding engine 112 would “substitute” keywords, phrases or the like in the textual file with one or a selection of the matched generally accepted phrases from the CPT or ICD, step 30, and transmit the textual file to the health care provider for “acceptance or selection,” step 32. For example, in real or near real time, the textual file is streamed or transmitted to the invoice coding engine 112 which returns a processed textual file to the display associated with workstation 102. For example, the doctor's note above “The patient exhibited a seizure based on XYZ conditions” after processing by methods as outlined by the methods and procedures herein would be displayed to the doctor in the electronic health record as “The patient exhibited a seizure (please select (a) febrile seizure, (b) toxin induced seizure, or (c) epileptic seizure) based on XYZ conditions.” The choices (a), (b), or (c) may be ordered in a manner to emphasize reimbursement value. The health care provider would review the selections returned, step 34, and select the appropriate terminology, step 36. In certain embodiments, the appropriate terminology may mean the description presented that best fits the patient's condition as well as the highest expected reimbursement value. The selection may be made using a conventional input device, such as a mouse click (for example, by clicking on “toxin induced seizure”), a touch screen, a keyboard (by typing “A” for example), a microphone (by saying (c) or epileptic for example). Alternatively, instead of displaying the text, the system may use the text to speech engine 110ₜₜₛ such that the speaker outputs audio such as, for example, “please select for seizure: febrile seizure, toxin induced seizure, or epileptic seizure. Next, after the selections, any follow on selections are made to facilitate appropriate terminology for coding the beneficial reimbursement diagnosis, step 38. For example, if the seizure was epileptic, on selection, the electronic health record would be changed to “The patient exhibited an epileptic seizure (please select (a) generalized seizure or (b) focal seizure) based on XYZ conditions.” The health care provider may select, for example (a) generalized seizure. At which time, still another revised electronic health record is provided such as, for example, “The patient exhibited a generalized, epileptic seizure (please select (a) Tonic-Clonic Seizure, (b) Tonic Seizure, or (c) Clonic Seizure) based on XYZ conditions.” Next, it is determined if any additional selections are necessary, step 40. If no additional selections are necessary, the electronic health record is finalized and sent for invoicing, step 42, which may be automatic as described. If additional selections are necessary, the steps 304A to 308A are repeated.

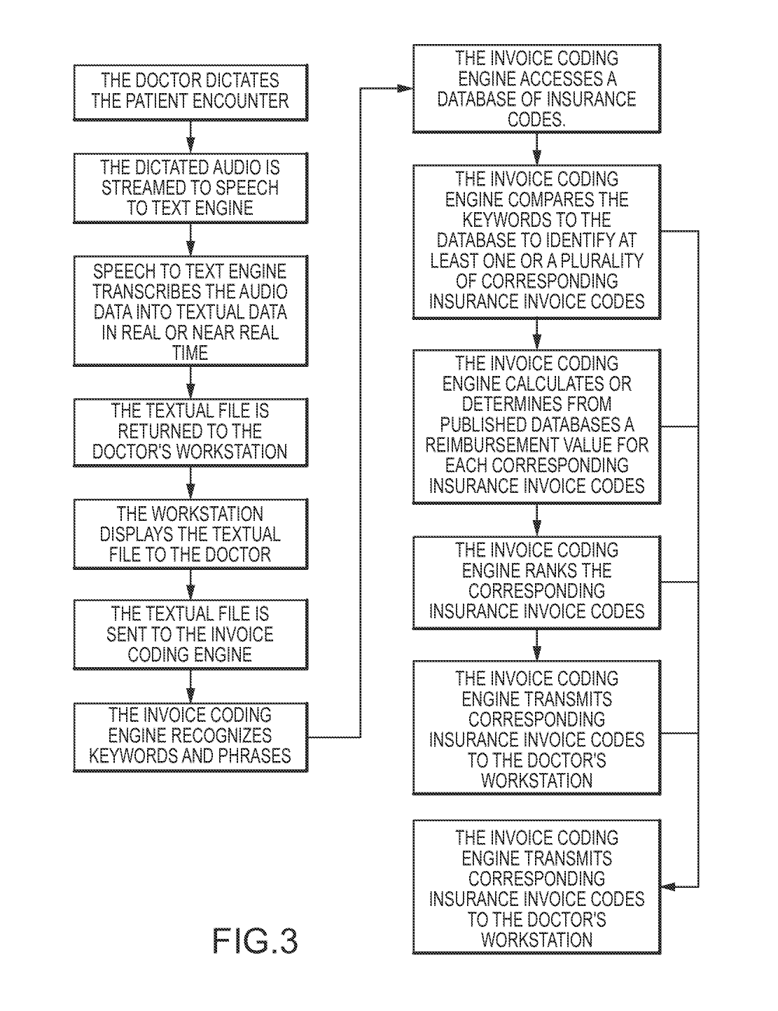

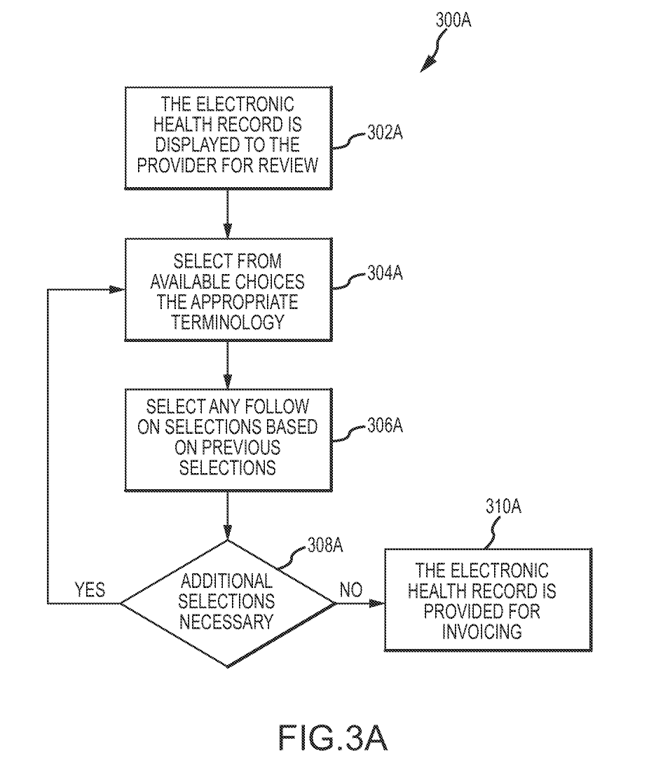

With reference now to FIG. 2A, a flowchart 200A is provided with an exemplary method of receiving patient notes using a doctor's dictation. While flowchart 200A is provided in certain discrete steps, one of ordinary skill in the art will recognize that the steps identified may be broken into multiple steps or multiple steps in the flowchart may be combined into a single step. Moreover, the sequence of events provided by the flowchart may be altered or rearranged without departing from the technology of the present application. With that in mind, flowchart 200A starts with the doctor dictating a patient encounter, step 202. The interface 104, such as a microphone, would transmit (i.e., stream) audio data to processor 108, step 204. The processor 108 would cause the audio data to be stored in a memory, such as memory 106, as an audio file, step 206. Alternatively, the audio data may be streamed to a remote memory and cached or stored for processing. The processor 108 would then cause the audio file to be sent to a speech to text engine 110, step 208. Alternatively, the audio data may be streamed directly to a speech to text engine 110, which may eliminate the storing step and transmitting the file step. Of course, instead of transmitting the audio data via a batch file transfer, the audio data is streamed directly to the speech to text engine. The speech to text engine may be remotely located in a server, for example, as shown, or contained locally in workstation 102. Speech to text engine 110 converts the audio file to a textual file, step 210. In the medical arts, speech to text engine 110 typically would be provided with a grammar file associated with the medical profession. Speech to text engine 110 would send the textual file to an invoice coding engine 112, step 212. Alternatively, the speech to text engine 110 may provide the textual file to processor 108 for display to the doctor and processor 108 or speech to text engine 110 may send the textual file to invoice coding engine 112 as will be explained further below with respect to FIG. 3.

Alternatively to using a speech to text engine 110, an audio file may be transmitted to a medical transcriptionist that manually types the notes into a textual file. In still other embodiments, the doctor may handwrite notes regarding the patient encounter. The notes would be provided to a medical transcriptionist that would manually type the notes into a textual file. Using an alternative methodology will make some of the real or near real time feedback described below with reference to the figures not as practical as when the doctor's notes are streamed to the speech to text engine 110. In any event, the alternative transcription methods may be used to provide the textual file to the invoice coding engine 112 as will be explained below.

As explained above, the invoice coding engine 112 is configured to recognize certain keywords, phrases, or the like relating to insurance coding. For example, the invoice coding engine 112 may be configured to match words or phrases in the doctor's notes to keywords and phrases contained in the CPT or ICD. In other words, on reception of the textual file, invoice coding engine 112 may again begin recognizing words, phrases or the like (generically keywords) according to a rules database contained in a memory 114 associated with invoice coding engine 112, step 214. Optionally, the recognized words may be stripped into a coding file or tagged in some conventional manner. The invoice coding engine 112 accesses a database 116 of insurance codes, such as, for example, the CPT or ICD, step 216. Using the recognized keywords, the invoice coding engine compares the keywords to the database to identify a plurality of insurance invoice codes that correspond to the keywords identified from the textual file of the patient encounter, step 218. Once the plurality of insurance invoice codes that are potentially applicable to the patient encounter are determined (in step 218), the invoice coding engine 112 determines the reimbursement value of each of the identified plurality of insurance invoice codes, step 220. The determination may be accomplished using a formula or a look up in a reimbursement database for the prevailing or negotiated rates associated with each insurance invoice code. Once the reimbursement value is determined, the invoice coding engine 112 rank orders the plurality of codes, step 222. The rank ordered codes are provided to the biller, step 224, such that the invoice may be prepared and submitted. In many instances, the health care provider, as explained above with reference to flowchart 20, may have already selected all the appropriate codes, etc., such that the invoice coding engine 112 only provides a single possibility to the biller. However, in other instances, the continued processing of the electronic health record may result in still additional possibilities from which the biller may select. If the biller makes selections, in some cases the selections may need to be approved by a health care provider, whether the one who actually produced the electronic health record or an administrator authorized to review and select. As explained further below, the invoice coding engine 112 or a separate invoicing engine 118 may be provided to prepare, format, and send the invoice to the insurance company. Formatting an invoice for electronic data transfer to an insurance company is generally known in the art and will not be further explained herein.

Rank ordering of the plurality of insurance invoice codes may be a simple listing of highest to lowest reimbursement value, may be a simple listing of the highest confidence to lowest confidence applicable insurance code, or may be a combination thereof. Thus, an insurance code of ABC may have a confidence value of 90% and a reimbursement value of $200.00 USD; whereas, an insurance code of DEF may have a confidence value of 75% and a reimbursement value of $220.00 USD and, finally, an insurance code of GHI may have a confidence value of 55% and a reimbursement value of $330 USD. Ranking the insurance codes based on a confidence level would result in a ranking of codes ABC, DEF, GHI as the (1), (2), and (3) codes. Ranking the insurance codes based on just reimbursement value would result in a ranking of GHI, DEF, ABC and the (1), (2), and (3) codes. Whereas a combination of confidence and reimbursement value may result in a ranking of (confidence * reimbursement value) GHI ($181.50), ABC ($180.00), DEF ($165). These are but a few examples of possible ranking procedures. The above are simply exemplary methods to rank the insurance invoice codes and other methods may be possible.

The above example provides rank orders for codes on a code by code basis. A number of procedures and invoice codes may apply to patient encounter. The rank order may evaluate sets of codes for a patient encounter and order the sets of codes, where some of the individual codes in the sets may be identical. A consideration when evaluating sets of codes includes whether a given procedure is a primary or secondary condition within the set. For example, a primary condition test may be reimbursed at 80 to 90% of the invoiced dollars; whereas, a secondary condition test may be reimbursed at a lower rate as it was less necessary for the treatment of the primary condition associated with the patient encounter.

With reference now to FIG. 2B, a flowchart 200B is provided with an exemplary method of receiving patient notes using a doctor's manually inputted notes to the Electronic Health Record. Flowchart 200B is similar to 200A above in certain respects. While flowchart 200B is provided in certain discrete steps, one of ordinary skill in the art will recognize that the steps identified may be broken into multiple steps or multiple steps in the flowchart may be combined into a single step. Moreover, the sequence of events provided by the flowchart may be altered or rearranged without departing from the technology of the present application. With that in mind, flowchart 200B starts with the doctor typing or using some other means to textually input a patient encounter, step 202B. For example, the doctor may use a digital tablet, a light pen, a touch interface, a keyboard, a combination thereof or the like to input the electronic health record. The interface 104 would transmit the textual data to processor 108, step 204B; perhaps by writing a file, downloading the data, or the like. The processor 108 would cause the textual file of the patient encounter to be stored in a memory, such as memory 106, as an audio file, step 206B. The textual file would be transmitted by a processor, such as processor 108, to the invoice coding engine, step 212B. As can be appreciated, unlike flowchart 200A, flowchart 200B does not include the steps associated with converting an audio file to a textual file.

The invoice coding engine 112 would be configured to recognize certain keywords, phrases, or the like relating to insurance coding. For example, the invoice coding engine 112 may be configured to match words or phrases in the doctor's notes to keywords and phrases contained in the CPT or ICD. In other words, on reception of the textual file, invoice coding engine 112 would begin recognizing words, phrases or the like (generically keywords) according to a rules database contained in a memory 114 associated with invoice coding engine 112, step 214B. Optionally, the recognized words may be stripped into a coding file or tagged in some conventional manner. The invoice coding engine 112 accesses a database 116 of insurance codes, such as, for example, the CPT or ICD, step 216B. Using the recognized keywords, the invoice coding engine compares the keywords to the database to identify a plurality of insurance invoice codes that correspond to the keywords identified from the textual file of the patient encounter, step 218B. Once the plurality of insurance invoice codes that are potentially applicable to the patient encounter are determined (in step 218B), the invoice coding engine 112 determines the reimbursement value of each of the identified plurality of insurance invoice codes, step 220B. The determination may be accomplished using a formula or a look up in a reimbursement database for the prevailing or negotiated rates associated with each insurance invoice code. Once the reimbursement value is determined, the invoice coding engine 112 rank orders the plurality of codes, step 222B. The rank ordered codes are provided to the biller, step 224B, such that the invoice may be prepared and submitted. In many instances, the health care provider, as explained above with reference to flowchart 20, may have already selected all the appropriate codes, etc., such that the invoice coding engine 112 only provides a single possibility to the biller. However, in other instances, the continued processing of the electronic health record may result in still additional possibilities from which the biller may select. As explained further below, the invoice coding engine 112 or a separate invoicing engine 118 may be provided to prepare, format, and send the invoice to the insurance company. Formatting an invoice for electronic data transfer to an insurance company is generally known in the art and will not be further explained herein.

With reference now to FIG. 2C, a flowchart 200C is provided with an exemplary method of receiving patient notes using a doctor's dictation, notes or the like, where the notes are provided to a transcription service for conversion to a textual file. Flowchart 200C is similar to 200A and 200B above in certain respects. While flowchart 200C is provided in certain discrete steps, one of ordinary skill in the art will recognize that the steps identified may be broken into multiple steps or multiple steps in the flowchart may be combined into a single step. Moreover, the sequence of events provided by the flowchart may be altered or rearranged without departing from the technology of the present application. With that in mind, flowchart 200C starts with the doctor recording the notes of the patient encounter external to the electronic health record, step 202C. For example, the doctor may handwrite the notes; the doctor may use a Dictaphone, or the like. The recordation of the patient encounter is transmitted to a transcription service, step 204C. In many cases, the doctor will use a telephone to record an audio file that is transmitted to a batch style dictation transcription service. The transcription service may be a typist or a speech to text engine. The transcription service would return a textual file for the electronic health record, step 206B. The textual file would be transmitted by a processor, to the invoice coding engine, step 212B.

The invoice coding engine 112 would be configured to recognize certain keywords, phrases, or the like relating to insurance coding. For example, the invoice coding engine 112 may be configured to match words or phrases in the doctor's notes to keywords and phrases contained in the CPT or ICD. In other words, on reception of the textual file, invoice coding engine 112 would begin recognizing words, phrases or the like (generically keywords) according to a rules database contained in a memory 114 associated with invoice coding engine 112, step 214B. Optionally, the recognized words may be stripped into a coding file or tagged in some conventional manner. The invoice coding engine 112 accesses a database 116 of insurance codes, such as, for example, the CPT or ICD, step 216B. Using the recognized keywords, the invoice coding engine compares the keywords to the database to identify a plurality of insurance invoice codes that correspond to the keywords identified from the textual file of the patient encounter, step 218B. Once the plurality of insurance invoice codes that are potentially applicable to the patient encounter are determined (in step 218B), the invoice coding engine 112 determines the reimbursement value of each of the identified plurality of insurance invoice codes, step 220B. The determination may be accomplished using a formula or a look up in a reimbursement database for the prevailing or negotiated rates associated with each insurance invoice code. Once the reimbursement value is determined, the invoice coding engine 112 rank orders the plurality of codes, step 222B. The rank ordered codes are provided to the biller, step 224B, such that the invoice may be prepared and submitted. In many instances, the health care provider, as explained above with reference to flowchart 20, may have already selected all the appropriate codes, etc., such that the invoice coding engine 112 only provides a single possibility to the biller. However, in other instances, the continued processing of the electronic health record may result in still additional possibilities from which the biller may select. As explained further below, the invoice coding engine 112 or a separate invoicing engine 118 may be provided to prepare, format, and send the invoice to the insurance company. Formatting an invoice for electronic data transfer to an insurance company is generally known in the art and will not be further explained herein.

Referring now to FIG. 3, a flowchart 300 is provided with an exemplary method of receiving patient notes using a doctor's dictation. While flowchart 300 is provided in certain discrete steps, one of ordinary skill in the art will recognize that the steps identified may be broken into multiple steps or multiple steps in the flowchart may be combined into a single step. Moreover, the sequence of events provided by the flowchart may be altered or rearranged without departing from the technology of the present application. With that in mind, flowchart 300 starts similar to flowchart 200 with the doctor dictating a patient encounter, step 302. The dictated audio data is streamed directly to the speech to text engine 110, step 304. The dictated audio data is received by the microphone, which is a particular interface 104 (above), and streams the audio data directly to the speech to text engine for transcription to textual data in real or near real time, step 306. If the speech to text engine 110 is not incorporated in the workstation 102, the speech to text engine returns the textual file to the workstation 102, step 308, and the workstations 102 displays the textual file (such as via a word document, clipboard, or the like) on a display, which may be part of interface 104, step 310. The textual file also is transmitted to the invoice coding engine 112, step 312.

The invoice coding engine 112 would be configured to recognize certain keywords, phrases, or the like relating to insurance coding. For example, the invoice coding engine 112 may be configured to match words or phrases in the doctor's notes to keywords and phrases contained in the CPT or ICD. In other words, on reception of the textual file, invoice coding engine 112 would begin recognizing words, phrases or the like (generically keywords) according to a rules database contained in a memory 114 associated with invoice coding engine 112, step 314. Optionally, the recognized words may be stripped into a coding file or tagged in some conventional manner. The invoice coding engine 112 accesses a database 116 of insurance codes, such as, for example, the CPT or ICD, step 316. Using the recognized keywords, the invoice coding engine compares the keywords to the database to identify a plurality of insurance invoice codes that correspond to the keywords identified from the textual file of the patient encounter, step 318. Once the plurality of insurance invoice codes that are potentially applicable to the patient encounter are determined (in step 218), the invoice coding engine 112 determines the reimbursement value of each of the identified plurality of insurance invoice codes, step 320. The determination may be accomplished using a formula or a look up in a reimbursement database for the prevailing or negotiated rates associated with each insurance invoice code. Once the reimbursement value is determined, the invoice coding engine 112 rank orders the plurality of codes, step 322. The rank ordered codes are provided to the biller, step 324, such that the invoice may be prepared and submitted. As explained further below, the invoice coding engine 112 or a separate invoicing engine 118 may be provided to prepare, format, and send the invoice to the insurance company. Formatting an invoice for electronic data transfer to an insurance company is generally known in the art and will not be further explained herein.

Steps 312 to 324 are substantially the same as steps 212 to 224 described above. In the case of flowchart 300, however, the textual file of the patient encounter is provided to the doctor in real or near real time and displayed to the doctor. In certain embodiments, steps 312 to at least 320 and perhaps 322 also are performed in real or near real time. In other words, the speech to text engine streams the textual file as it is created to workstation 102 for display in real or near real time and streams the textual file as it is created to invoice coding engine 112. Invoice coding engine 112 recognizes and begins providing insurance codes and potentially calculates a confidence level as the textual file is received.

As codes are recognized, reimbursement value recognized, or ranked, the invoice coding engine may return to the workstation 102 for display to the doctor certain information about the various potential codes matching the present textual file containing the doctor's notes. The certain information may provide, for example, suggestions to facilitate a particular code being accepted by an insurance company for reimbursement. For example, as outlined above, a particular textual file of a patient encounter may provide:
An insurance code of ABC may have a confidence value of 90% and a reimbursement value of $200.00 USD;
An insurance code of DEF may have a confidence value of 75% and a reimbursement value of $220.00 USD; and
An insurance code of GHI may have a confidence value of 55% and a reimbursement value of $330 USD.

Thus, the insurance coding engine may return to the doctor information regarding the insurance codes ABC, DEF, and GHI. Part of the information returned may be expected actions or information called for by the CPT or ICD. Thus, on seeing this information, the doctor may enhance the patient encounter. For example, the doctor may perform some functions that increase the confidence of code DEF from 75% to 95%. Thus, code DEF may be the highest expected reimbursement and/or the highest confidence code to be selected for reimbursement.

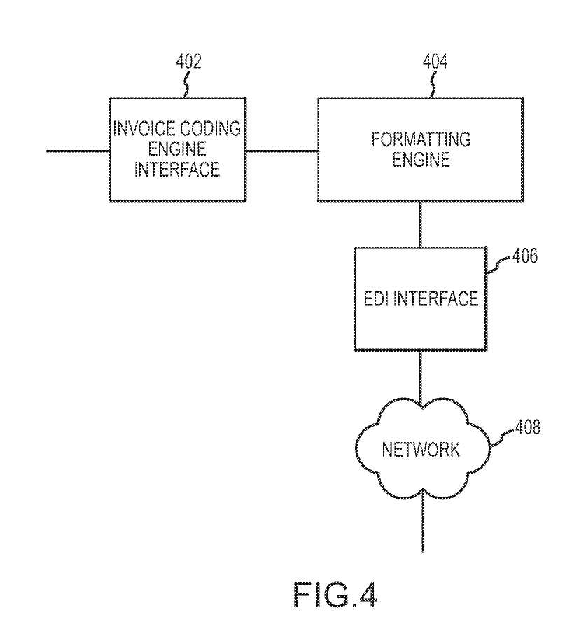

As mentioned above, medical invoicing may be accomplished using an electronic data interchange (EDI). EDI is standardized under the Health Insurance Portability and Accountability Act (HIPAA). The EDI standardizes the rules for field formats and the like to allow invoicing and processing using electronic file transfers. These rules are likely to change from time to time. However, because the file format is standardized, it is possible to provide an automated invoicing engine connected to a network as shown in FIG. 4. The invoicing engine 118 would receive input from the invoice coding engine at an invoice coding engine interface 402. The invoice coding engine interface 402 would either receive one of the plurality of corresponding insurance invoice codes or it may be programmed to select one of the plurality of corresponding insurance invoice codes. For example, the invoice coding engine interface 402 may receive the corresponding insurance invoice codes ABC, DEF, and GHI with any associated information (such as confidence levels and reimbursement values). The invoice coding engine interface 402 may select one of the corresponding insurance invoice codes based on a pre-established selection criteria, such as confidence level. Alternatively, the invoice coding engine interface 402 may simply receive the highest ranked insurance invoice code. The insurance invoice code and any necessary patient encounter information from the textual file of the patient encounter is provided to the formatting engine 404 that arranges the information according to the rules associated with HIPAA electronic data interchange file formatting requirements. Thus, the formatting engine 404 produces the electronic invoice. The electronic invoice is transmitted by the EDI interface 406 to an EDI compatible network 408 that transmits the electronic invoice to the insurance company for formatting.

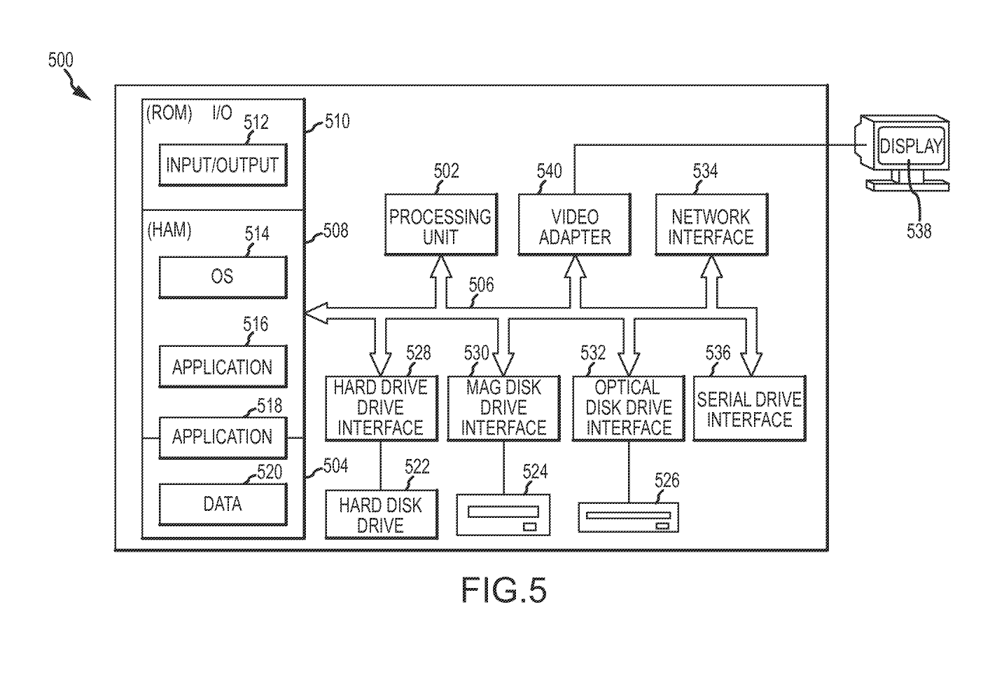

Referring now to FIG. 5, a functional block diagram of a typical workstation 500 for the technology of the present application is provided. Workstation 500 may be any of the above described engines, workstations, servers, or the like. The workstation 500 is shown as a single, contained unit, such as, for example, a desktop, laptop, tablet, handheld, smart phone, personal digital assistant, or mobile processor, but the workstation 500 may comprise portions that are remote and connectable via a network connection such as via a LAN, a WAN, a WLAN, a WiFi Network, Internet, or the like. Generally, the workstation 500 includes a processor 502, a system memory 504, and a system bus 506. The system bus 506, which may follow any conventional protocol such as, for example, PCI or PCI-express, couples the various system components and allows data and control signals to be exchanged between the components. The system memory 504 generally comprises both a random access memory (RAM) 508 and a read only memory (ROM) 510. The ROM 510 generally stores a basic operating information system such as a basic input/output system (BIOS) 512. The RAM 508 often contains the basic operating system (OS) 514, application software 516 and 518, and data 520. The system memory 504 contains the code for executing the functions and processing the data as described herein to allow the present technology of the present application to function as described. The workstation 500 generally includes one or more of a hard disk drive 522 (which also includes flash drives, solid state drives, etc. as well as other volatile and non-volatile memory configurations), a magnetic disk drive 524, or an optical disk drive 526. The drives are connected to the bus 506 via a hard disk drive interface 528, a magnetic disk drive interface 530 and an optical disk drive interface 532. Application modules and data may be stored on a disk, such as, for example, a hard disk installed in the hard disk drive (not shown). The workstation 500 has network connection 534 to connect to a local area network (LAN), a wireless network, an Ethernet, the Internet, or the like, as well as one or more serial port interfaces 536 to connect to peripherals, such as a mouse, keyboard, microphone, touch screen, light pen, modem, or printer. The workstation 500 also may have USB ports or wireless components not shown. Workstation 500 typically has a display or monitor 538 connected to bus 506 through an appropriate interface, such as a video adapter 540. Monitor 538 may be used as an input mechanism using a touch screen, a light pen, or the like. On reading this disclosure, those of skill in the art will recognize that many of the components discussed as separate units may be combined into one unit and an individual unit may be split into several different units. Further, the various functions could be contained in one personal computer or spread over several networked personal computers. The identified components may be upgraded and replaced as associated technology improves and advances are made in computing technology.

Those of skill would further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention. The above identified components and modules may be superseded by new technologies as advancements to computer technology continue.

The various illustrative logical blocks, modules, and circuits described in connection with the embodiments disclosed herein may be implemented or performed with a general purpose processor, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

1. An apparatus, comprising:
an invoice coding engine, the invoice coding engine comprising;
a recognizer module;
a comparator module; and
a memory,
wherein the invoice coding engine receives an electronic patient health record containing data from a patient encounter in a format compatible with the invoice coding engine from a health care provider, the invoice coding engine inputs the data to the recognizer module to recognize data in the patient health record, the recognizer module recognizes key data contained in the data,
wherein the key data is input to the comparator module such that the comparator compares the key data to generally accepted data to determine at least one applicable generally accepted data that corresponds to the key data,
wherein the invoice coding engine replaces the data from the electronic patient health record with the at least one generally accepted data that corresponded to the key data to generate a modified electronic patient health record, and
wherein the invoice coding engine transmits the modified electronic patient health record for processing.

2. The apparatus of claim 1, wherein the generally accepted data comprises at least one of a Current Procedural Terminology database, an International Statistical Classification of Diseases and Related Health Problems database, or a combination thereof.

3. The apparatus of claim 1, wherein the invoice coding engine further identifies at least one insurance invoice code that corresponds to the at least one applicable generally accepted data.

4. The apparatus of claim 3, wherein the invoice coding engine further calculates a reimbursement value for each of the at least one insurance invoice codes.

5. The apparatus of claim 4, wherein the invoice coding engine further ranks the corresponding insurance invoice codes to optimize a revenue to the health care provider.

6. The apparatus of claim 5, wherein the invoice coding engine is coupled to a format engine, the format engine generates an electronic data interchange that is transmitted for payment.

7. A method of generating a patient health record using at least one processor, the method comprising the steps of:
receiving at least one note describing a patient encounter of a health care provider;
recognizing from the at least one note at least one key data;
comparing the at least one key data to a database of generally accepted data;
identifying at least one generally accepted data for each of the at least one key data;
replacing the at least one key data with each of the at least one generally accepted data;
generating a modified note using the at least one generally accepted data for each of the key data; and
transmitting the modified note to the health care provider, wherein the note provides for the health care provider to select the most appropriate terminology of the at least one generally accepted data.

8. The method of claim 7 wherein the at least one note received comprises an electronic health record.

9. The method of claim 8 wherein the electronic health record is generated by a method comprising the steps of:
receiving audio from the health care provider;
converting the audio from the health care provider into textual data;
inputting the textual data into the electronic health record.

10. The method of claim 8 wherein the electronic health record is generated by input using at least one of a keyboard, a touch screen, a light pen, a mouse, or a combination thereof.

11. The method of claim 7 further comprising the step of:
determining a reimbursement value for each of the at least one generally accepted data.

12. The method of claim 11 further comprising the step of:
ranking each of the at least one generally accepted data based on the determined reimbursement value.

13. The method of generating an electronic health record based on a patient encounter with a health care provider, comprising the steps performed on at least one processor of:
generating an initial electronic health record based on at least one note of a health care provider created during a patient encounter;
transmitting the initial electronic health record to an invoice coding engine;
receiving from the invoice coding engine a modified electronic health record, the modified electronic health record having at least one key data replaced by at least one generally accepted data by the invoice coding engine;
confirming the at least one generally accepted data in the modified electronic health record is appropriate; and
saving a final electronic health record for transmission to a biller wherein the biller provides an electronic file to a payer such that the health care provider is paid for the patient encounter.

14. The method of claim 13 wherein the modified electronic health record contains a plurality of generally accepted data for the key data and the confirming step further comprises the step of selecting one of the plurality of generally accepted data.

15. The method of claim 14 wherein the selection of one of the plurality of generally accepted data provides at least a second set of generally accepted data to be confirmed.

16. The method of claim 13, wherein the step of generating the initial electronic health record comprises the health care provider dictating the at least one note, transmitting the dictation to a speech to text engine, and generating a textual file from the dictation comprising the initial electronic health record.

17. The method of claim 16 wherein the method is in real or near real time.

18. A system to generate an electronic health record optimizing the electronic health record with generally accepted data, the system comprising:
a workstation, the workstation comprising an interface to receive notes from a health care provider for a patient encounter;
an invoice coding engine, the invoice coding engine comprising a recognize module and a comparator module;
a memory comprising generally accepted data corresponding to insurance invoice codes; and
a network coupling the workstation, the invoice coding engine, and the memory,
wherein the health care provider generates an initial electronic health record at the workstation using the interface to input the notes, the workstation transmits the initial electronic health record to the invoice coding engine where the recognizer recognizes key data in the initial electronic health record, the invoice coding engine accesses the memory and the comparator compares the key data to the generally accepted data, the invoice coding engine replaces the key data in the initial electronic health record with the generally accepted data to generate a modified electronic health record, the modified electronic health record is transmitted to the workstation wherein the health care provider confirms the generally accepted data and generates a final electronic health record for transmission to a biller.

19. The system of claim 18 wherein the transmission is a streaming transmission.

20. The system of claim 19, wherein the initial electronic health record is generated by streaming dictation to a speech recognition engine that converts the dictation to text and populates the fields of the initial electronic health record with the text.
